(19) United States
(12) Patent Application Publication
(10) Pub. No.: US 2026/0200772 A1
(43) Pub. Date: Jul. 16, 2026

(54) GOVERNANCE-CENTRIC, ENERGY-AWARE AERATION CONTROL SYSTEM AND METHOD FOR BIOLOGICAL WASTEWATER TREATMENT

(71) Applicant: Jae Kwang Park, VERONA, WI (US)

(72) Inventor: Jae Kwang Park, VERONA, WI (US)

(21) Appl. No.: 19/456,609

(22) Filed: Jan. 22, 2026

(51) Int. Cl. C02F 1/74

(52) U.S. Cl. CPC C02F 1/74

(57) ABSTRACT

An AI-governed aeration control system and method for biological wastewater treatment processes are disclosed. The system employs an energy-aware, governance-centric supervisory architecture that decouples predictive aeration estimation from physical airflow actuation. Predictive airflow or dissolved oxygen estimates generated using machine learning models trained on historical plant-specific data are treated as non-binding advisory inputs. A supervisory governance layer evaluates dissolved oxygen operating envelopes, process sensor confidence scores, and biological risk indicators, including nutrient concentration trends such as ammonia, to conditionally permit, constrain, or override predictive recommendations. The system utilizes multi-rate control, time-based envelope compliance metrics, zone-level airflow redistribution, and bounded authority modes to maintain biological process stability while reducing aeration energy consumption. The invention is particularly advantageous for low dissolved oxygen simultaneous nitrification and denitrification (SND) operation, while remaining applicable to conventional activated sludge and biological nutrient removal systems.

### CROSS REFERENCE TO RELATED PATENT APPLICATIONS

This application is a Continuation-in-Part (CIP) of U.S. patent application Ser. No. 18/414,566, published as U.S. Publication No. 2025/0231538, entitled “AI-Driven Optimization and Control of Aeration in Wastewater Treatment Plants in Real Time”. The entire contents of the foregoing application are incorporated herein by reference to the extent consistent with the present disclosure.

### FIELD OF THE INVENTION

The present invention relates to systems and methods for controlling aeration in biological wastewater treatment processes. More particularly, the invention relates to governance and supervisory governance architectures that constrain and regulate the application of predictive or data-driven aeration recommendations under conditions of sensor uncertainty and biological risk.

### BACKGROUND OF THE INVENTION

Aeration is widely recognized as the most energy-intensive operation in wastewater treatment plants, commonly accounting for approximately 40-70% of total facility electricity consumption. As a result, significant efforts have been directed toward improving aeration efficiency through automation and advanced control strategies.

Conventional aeration control systems typically rely on proportional-integral-derivative (PID) control loops that regulate blower output to maintain a fixed dissolved oxygen (DO) setpoint. While such systems are straightforward to implement, they are inherently reactive and frequently lead to over-aeration, actuator cycling, and inefficient energy use under variable influent and biological loading conditions.

More recently, predictive and data-driven approaches have been proposed to improve aeration efficiency. These approaches include using machine learning and artificial intelligence models to forecast influent conditions, oxygen demand, and optimal airflow or DO targets based on historical operational data.

For example, the AI-driven aeration system described in U.S. patent application Ser. No. 18/414,566 employs pattern recognition machine learning to generate predictive recommendations for airflow or dissolved oxygen to optimize aeration. Similar predictive approaches have been described in academic literature and patent publications.

While predictive aeration systems can reduce energy consumption under stable conditions, such systems generally assume that model outputs can be directly enforced as control commands. This assumption becomes problematic when sensor reliability is degraded or biological process dynamics deviate from historical patterns.

Simultaneous nitrification and denitrification (SND) processes have been adopted to improve nitrogen removal efficiency while reducing aeration energy consumption. SND operation typically relies on maintaining low dissolved oxygen concentrations that allow aerobic and anoxic reactions to occur concurrently.

Operation at low dissolved oxygen concentrations introduces significant process sensitivity. The allowable operating window is narrow, biological kinetics are nonlinear, and small disturbances in airflow or loading can lead to loss of nitrification or unstable effluent quality.

Dissolved oxygen sensors operating at low concentrations are subject to noise, fouling, calibration drift, and delayed response. Nutrient sensors, including ammonia probes, often exhibit transport lag and signal variability that limit their suitability for high-frequency feedback control.

As a result, direct enforcement of predictive aeration recommendations or direct nutrient-based feedback control can exacerbate instability, leading to blower oscillation, frequent manual intervention, and reduced operator confidence.

Existing control approaches lack mechanisms to explicitly assess sensor reliability, distinguish measurement artifacts from true biological risk, or govern when predictive recommendations should be applied, limited, or overridden.

Although predictive aeration control systems can improve energy efficiency under stable operating conditions, their effectiveness diminishes when applied to processes characterized by narrow operating windows, delayed biological response, and uncertain sensor measurements.

These limitations are particularly pronounced in biological treatment processes operated at reduced dissolved oxygen concentrations, where conventional control assumptions regarding measurement reliability and actuator response are no longer valid.

In such environments, direct enforcement of predictive or optimized control outputs can lead to excessive actuator oscillation, loss of biological stability, and increased operator intervention.

Despite extensive research into predictive and data-driven aeration optimization, there remains a lack of control architectures that explicitly govern when predictive recommendations should be trusted, constrained, or overridden based on process risk and measurement confidence.

Accordingly, there exists a need for an aeration control approach that retains the benefits of predictive optimization while introducing a supervisory governance layer that prioritizes biological stability and process safety.

The present invention addresses this need by introducing a governance-centric aeration control architecture that decouples predictive estimation from physical actuation and conditionally applies predictive recommendations based on sensor confidence, compliance with the operating envelope, and biological risk.

### SUMMARY OF THE INVENTION

The present invention provides systems and methods for governing aeration control in biological wastewater treatment processes. The invention introduces a governance-centric supervisory architecture that decouples predictive aeration estimation from physical actuation.

Predictive airflow or dissolved oxygen estimates generated by data-driven or machine-learning models are treated as non-binding advisory inputs rather than direct control commands.

A governance layer evaluates sensor confidence, time-based compliance with dissolved oxygen operating envelopes, and biological risk indicators, and conditionally permits, constrains, or overrides predictive recommendations prior to actuation, including through bounded authority and mode-dependent control logic.

Nutrient concentration measurements, including ammonia, may be used as supervisory indicators of biological risk rather than as real-time feedback control variables.

While particularly advantageous for low dissolved oxygen simultaneous nitrification and denitrification (SND) operation, the invention is not limited to SND processes.

### BRIEF DESCRIPTION OF THE DRAWINGS

FIG. 1: Schematic diagram of the system architecture, highlighting the integration of influent risk indicators (conductivity/temperature) to ensure sensor-agnostic stability.

FIG. 2: Flow diagram of the multi-rate control framework, depicting the high-frequency detection of leading indicators (ammonia spikes) and decoupled total airflow bias updates.

FIG. 3: Illustration of a multi-zone basin with DO operating envelopes, showing how time-based compliance manages localized aeration distribution.

FIG. 4: Signal processing logic for dissolved oxygen confidence scoring, ensuring low-reliability measurements do not drive critical control decisions.

FIG. 5: Supervisory risk-based governance logic, illustrating the conditional application of energy-seeking bias based on correlations between ionic strength, temperature, and biological loading.

FIG. 6: Hierarchy of control modes and transitions, showing the prioritized override of Rescue and Fallback modes over standard Normal operation.

FIG. 7: Flowchart of the ML Training and Validation Pipeline, defining the mandatory “Shadow Mode” and safety thresholds required before active deployment.

### DETAILED DESCRIPTION OF THE INVENTION

### Scope and Applicability

Although the governance-centric aeration control architecture described herein is particularly advantageous for low dissolved oxygen simultaneous nitrification and denitrification (SND) operation, the invention is not limited to SND processes.

The systems and methods disclosed herein are applicable to a wide range of biological wastewater treatment processes, including conventional activated sludge and biological nutrient removal systems, in which aeration efficiency, sensor uncertainty, hydraulic transport delay, and process stability present persistent operational challenges.

### System Architecture Overview

In general, the system comprises a monitoring and evaluation module, a predictive airflow module, a supervisory governance module, a distribution control module, and associated physical aeration equipment, which collectively govern the application of aeration in response to process conditions. These modules cooperate such that predictive estimation remains advisory and non-binding unless and until permitted by supervisory governance logic.

### Predictive Airflow Estimation

The predictive airflow module generates a baseline airflow estimate using historical, plant-specific operational data. The baseline airflow estimate represents an anticipated biological oxygen demand under expected operating conditions and is advisory in nature, providing predictive insight without direct control authority over physical aeration equipment.

### Supervisory Governance

The supervisory governance module is interposed between predictive estimation and physical actuation and conditionally permits, constrains, delays, or overrides application of the baseline airflow estimate based on evaluated operational conditions. This architecture ensures functional decoupling between predictive estimation and physical aeration control.

### Dissolved Oxygen Operating Envelopes

Dissolved oxygen operating envelopes define permissible operating ranges that are evaluated over time rather than as instantaneous deviations from fixed setpoints. These envelopes establish biologically acceptable regions of operation and support time-based stability assessment.

### Sensor Confidence Evaluation

Sensor confidence scores may be computed using weighted combinations of signal variance, noise characteristics, flatlining detection, rate-of-change behavior, correlation with actuator response, and historical reliability indicators. These confidence scores are evaluated by the supervisory governance module to prevent unreliable measurements from exerting undue influence on control decisions.

### Supervisory Use of Nutrient Measurements

Nutrient measurements, including ammonia concentration, may be used to detect emerging biological instability and to trigger supervisory governance actions. Such measurements are treated as supervisory indicators rather than direct real-time feedback control variables.

### Hydraulic Transport Effects and Temporal Alignment

In certain embodiments, the predictive airflow module accounts for hydraulic transport effects within the wastewater treatment process when generating aeration-related recommendations. Such hydraulic transport effects may include, without limitation, flow propagation delay between upstream measurement locations and downstream biological reactors, hydraulic residence time within conduits, channels, or basins, and transport-induced timing of organic or nitrogenous load arrival at aerated zones.

The predictive airflow module may account for hydraulic transport effects using historical operating data, inferred transport behavior, simplified transport representations, empirical correlations, or combinations thereof, without requiring implementation of a specific hydraulic model. By accounting for hydraulic transport effects, predictive recommendations may be temporally aligned with actual biological loading conditions, rather than reacting solely to instantaneous sensor measurements.

The supervisory governance module continues to selectively permit, constrain, delay, or suppress physical actuation of predictive recommendations, thereby maintaining functional decoupling between predictive estimation and physical aeration control even in the presence of transport-induced delays.

### Observed Technical Effects

In simulation and historical replay studies using full-scale wastewater treatment plant data, the governance-centric architecture reduced airflow oscillations and improved aeration energy efficiency relative to direct predictive control approaches, while maintaining biological process stability.

### GOVERNANCE EVALUATION FRAMEWORK

### Sensor Confidence Evaluation

In certain embodiments, the supervisory governance module evaluates sensor confidence for one or more process measurements prior to using such measurements in governance decisions. Sensor confidence may be determined based on signal quality characteristics, historical reliability, or other confidence metrics as described herein. Measurements associated with reduced confidence may be down-weighted, excluded, or replaced with inferred or synthetic values, thereby preventing unreliable signals from directly influencing aeration control actions.

### Cross-Train Sensor Substitution Based on Confidence

In certain embodiments, when a sensor confidence evaluation for a given process measurement falls below an acceptable threshold in one treatment train or aeration zone, the supervisory governance module may utilize corresponding measurements from a parallel or adjacent treatment train for which sensor confidence remains high. Such cross-train substitution may be performed when the parallel treatment trains are hydraulically, biologically, or operationally comparable, or when historical correlations indicate consistent behavior between the trains.

In these embodiments, measurements from the higher-confidence sensor are used as supervisory reference inputs rather than direct feedback control variables, and may be scaled, normalized, or temporally aligned to account for differences in flow rate, loading, hydraulic transport delay, or operating conditions between the trains. This approach allows the governance framework to maintain situational awareness and control stability during localized sensor degradation, fouling, or failure, without requiring immediate sensor replacement or operator intervention.

### Automatic Sensor Cleaning and Confidence Reset

In certain embodiments, when a sensor confidence evaluation falls below a predefined threshold, the supervisory governance module may initiate or request an automatic sensor cleaning or maintenance action, including but not limited to air-blast cleaning, mechanical wiping, or chemical rinsing, where such capabilities are available.

Following execution of the sensor cleaning or maintenance action, the supervisory governance module may re-evaluate sensor performance using updated signal characteristics to determine whether sensor confidence has been restored. If post-cleaning confidence metrics satisfy acceptance criteria, the sensor measurements may be reintroduced into governance evaluation with appropriate weighting.

If sensor confidence remains below threshold following the cleaning action, the measurements may continue to be down-weighted, excluded, or substituted using alternative supervisory references, including cross-train measurements or inferred values. In this manner, sensor cleaning and confidence reset are treated as governance-level recovery mechanisms, ensuring robust operation in the presence of fouling, drift, or temporary sensor degradation without requiring immediate operator intervention.

### Dissolved Oxygen Operating Envelope Compliance

Aeration control may be governed using dissolved oxygen operating envelopes rather than fixed dissolved oxygen setpoints. Compliance with an operating envelope is evaluated over rolling or cumulative time windows, and time-based metrics—including duration, frequency, and persistence of envelope excursions—are used by the supervisory governance module to assess control risk and process stability.

### Biological Risk Indicators

The governance module evaluates biological risk indicators indicative of impending or ongoing biological instability. Such indicators may include sustained increases or abnormal rate-of-change in ammonia concentration, nitrate accumulation trends, deviations in oxygen uptake behavior, prolonged excursions from dissolved oxygen operating envelopes, or combinations thereof.

In further embodiments, biological risk indicators may include indirect or proxy measurements, such as influent ionic strength measured by inductive conductivity, wastewater temperature, or historical correlations between such auxiliary measurements and downstream nutrient behavior. These indicators are evaluated as supervisory signals, not real-time feedback variables.

### Conditional Permit, Constrain, Delay, or Override Logic

Based on evaluated sensor confidence, operating envelope compliance, and biological risk indicators, the supervisory governance module conditionally permits, constrains, delays, or overrides predictive aeration recommendations. Stable conditions permit bounded energy-seeking behavior, while elevated risk triggers conservative or protective actions prioritizing biological stability and effluent quality.

### Bounded Authority and Mode-Dependent Control

All aeration control actions are subject to bounded authority constraints, including airflow limits, rate-of-change limits, and mechanical, hydraulic, and biological safety constraints. Mode-dependent logic enforces increasingly restrictive authority as risk increases, with operator override retained at all times.

### General Statement Regarding the Figures

The figures described herein illustrate simplified schematic representations of example embodiments. Associated physical behavior, hydraulic transport effects, control logic, and process dynamics described in the specification may be inherent to the illustrated configurations without being explicitly depicted in the figures. The figures are provided for explanatory purposes and are not intended to limit the scope of the invention.

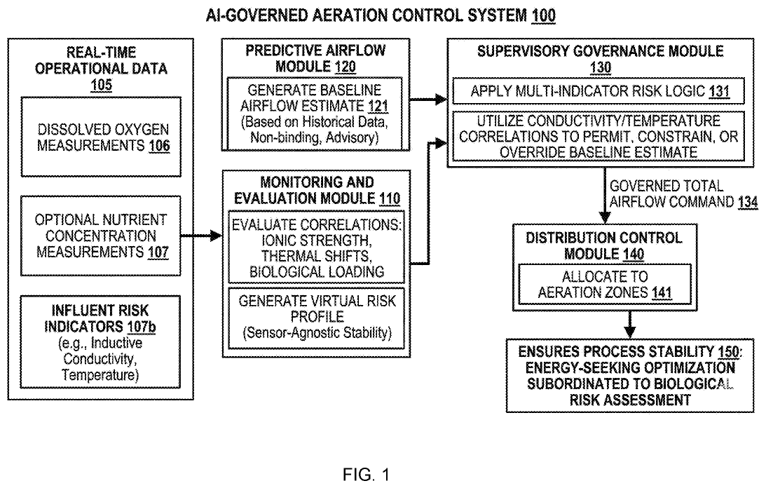

### System Architecture (FIG. 1)

Referring to FIG. 1, an AI-governed aeration control system 100 configured for sensor-agnostic stability is illustrated. The monitoring and evaluation module 110 receives real-time operational data 105, which includes dissolved oxygen measurements 106, optional nutrient concentration measurements 107, and influent risk indicators 107b, such as inductive (toroidal) conductivity and temperature.

A key feature of the monitoring module 110 is the evaluation of correlations between ionic strength (conductivity), thermal shifts, and biological loading. This allows the system to generate a virtual risk profile even in embodiments where nutrient sensors 107 are excluded or provide low-confidence signals.

The predictive airflow module 120 generates a baseline airflow estimate 121 based on historical data, which remains non-binding and advisory. The supervisory governance module 130 then applies multi-indicator risk logic 131. This logic utilizes the correlation between conductivity spikes and expected ammonia peaks to determine if the baseline estimate 121 should be permitted, constrained, or overridden.

By treating nutrient measurements as optional supervisory signals and utilizing conductivity/temperature as leading indicators, the system ensures process stability 150. The final governed total airflow command 134 is then allocated by the distribution control module 140 to the aeration zones 141, ensuring that energy-seeking optimization is always subordinated to biological risk assessment.

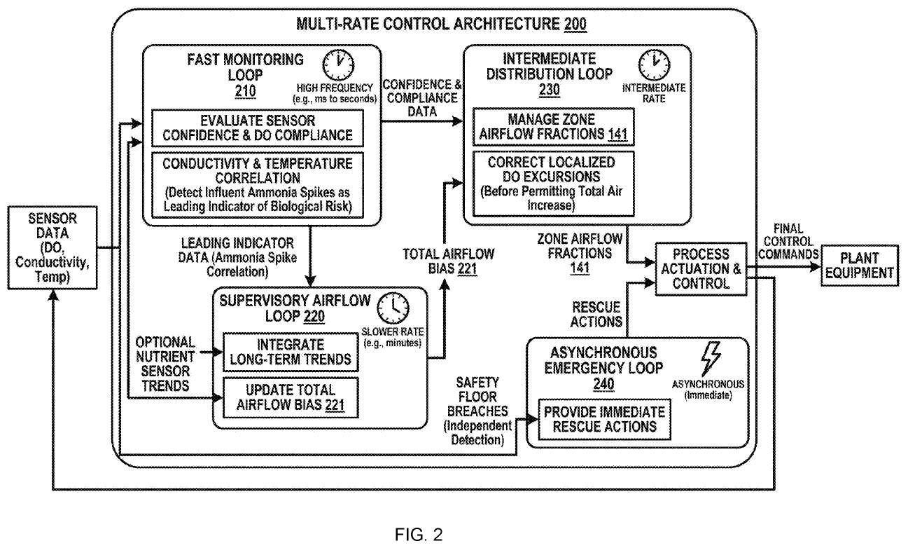

### Multi-Rate Control Framework (FIG. 2)

Referring to FIG. 2, the system operates using a multi-rate control architecture 200, which decouples process monitoring from actuation through distinct time-scaled loops. The Fast Monitoring Loop 210 operates at a high frequency (e.g., milliseconds to seconds) to evaluate sensor confidence and compliance with DO operating envelopes.

A key advancement in this architecture is the inclusion of Conductivity and Temperature Correlation within the fast loop. By analyzing inductive conductivity and temperature data, the system detects influent ammonia spikes as a leading indicator of biological risk. This correlation logic allows the system to preemptively assess process health even when physical nutrient sensors are absent or provide low-confidence signals.

The Supervisory Airflow Loop 220 operates at a slower rate (e.g., minutes) to update the total airflow bias 221. This loop integrates the long-term trends from both the optional nutrient sensors and the conductivity correlation engine to adjust the governed airflow command.

Simultaneously, the Intermediate Distribution Loop 230 manages zone airflow fractions 141 to correct localized DO excursions before the supervisory loop permits an increase in total air. Finally, the Asynchronous Emergency Loop 240 remains independent of these periodic updates, providing immediate rescue actions if hard safety floors are breached, ensuring that energy-seeking optimization never compromises biological stability

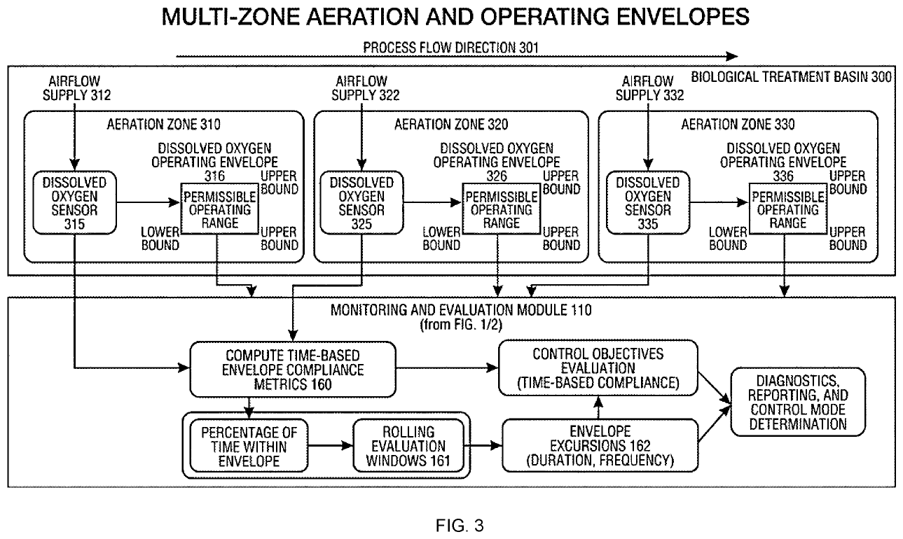

### Multi-Zone Aeration with Hydraulic Transport Effects (FIG. 3)

Referring to FIG. 3, a biological treatment system 300 is illustrated comprising a plurality of aeration zones 310, 320, and 330 arranged along a hydraulic flow path 301 extending from an upstream influent region toward a downstream effluent region. Such staged or compartmentalized aeration configurations are commonly employed in biological wastewater treatment processes, including systems configured for simultaneous nitrification and denitrification (SND) and other low dissolved oxygen operating regimes.

Each aeration zone 310-330 includes an associated air supply device 312, 322, 332, such as diffusers or aeration grids, and may further include one or more dissolved oxygen sensors 315, 325, 335 positioned to measure local oxygen conditions within the zone. The zones may differ in volume, mixing intensity, diffuser density, or biological function, resulting in non-uniform oxygen demand and hydraulic residence time across the treatment system.

For each zone, the system defines a dissolved oxygen operating envelope 316, 326, 336, each comprising a lower bound and an upper bound defining a permissible operating range rather than a fixed target setpoint.

Wastewater flow through the zones exhibits hydraulic transport delay and dispersion, such that changes in influent loading, flow rate, or composition propagate downstream over time rather than instantaneously affecting all zones. The predictive estimation module accounts for these transport effects when generating aeration-related recommendations, enabling anticipation of zone-specific loading conditions before measurable dissolved oxygen deviations occur.

### Time-Based Envelope Compliance Metrics

The monitoring and evaluation module 110 computes time-based envelope compliance metrics 160, including the percentage of time dissolved oxygen measurements remain within the defined operating envelopes.

Envelope compliance metrics may be computed over rolling evaluation windows 161 spanning minutes to multiple hours or longer, depending on process dynamics.

Envelope excursions 162, including duration and frequency, are recorded for diagnostics, reporting, and control mode determination.

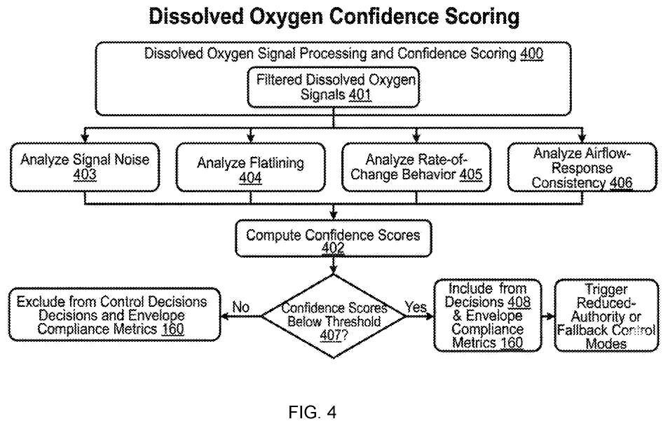

### Dissolved Oxygen Confidence Scoring (FIG. 4)

Referring to FIG. 4, dissolved oxygen signal processing and confidence scoring 400 are illustrated.

Filtered dissolved oxygen signals 401 are analyzed to compute confidence scores 402 based on signal noise 403, flatlining 404, rate-of-change behavior 405, and airflow-response consistency 406.

Measurements with confidence scores below a threshold 407 may be excluded from control decisions 408 and envelope compliance metrics 160, and may trigger reduced-authority or fallback control modes.

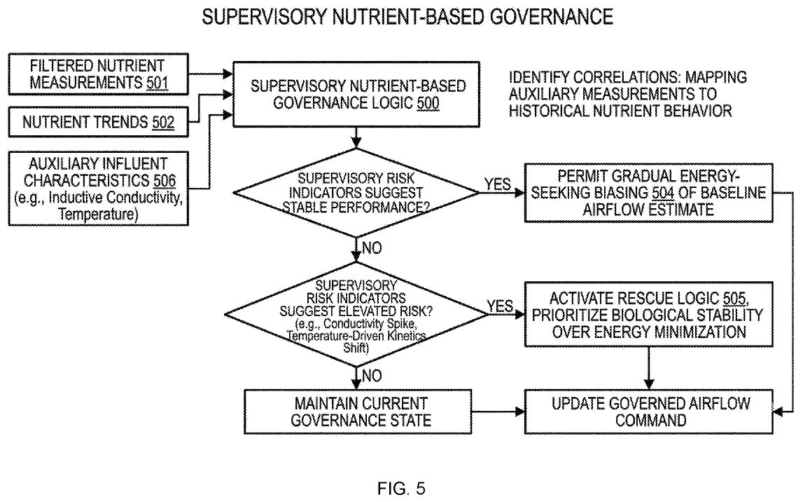

### Supervisory Nutrient-Based Governance (FIG. 5)

Referring to FIG. 5, the supervisory risk-based governance logic 500 is illustrated, depicting the decision-making framework used to conditionally apply aeration biasing. The logic evaluates process stability through a plurality of supervisory risk indicators, which may include Filtered Nutrient Measurements 501, Nutrient Trends 502, and Auxiliary Influent Characteristics 506 such as inductive conductivity and temperature. These indicators are utilized to assess the biological state of the process independently of the high-frequency dissolved oxygen control loops, ensuring that aeration optimization is always grounded in verified process safety.

A primary function of this module is to Identify Correlations by mapping auxiliary measurements, specifically influent conductivity and temperature spikes, to historical or expected biological loading patterns. By establishing these mathematical relationships, the governance logic 500 can detect emerging biological instability independently of, or in coordination with, a physical ammonia probe. This multi-indicator approach allows the system to generate a virtual risk profile, facilitating robust process protection even in embodiments where primary nutrient sensors are decommissioned, absent, or provide low-confidence data.

When the available supervisory risk indicators suggest stable or improving biological performance, the system Permits Gradual Energy-Seeking Biasing 504 of the baseline airflow estimate. This biasing is applied within strictly defined authority bounds, allowing the system to seek energy efficiency while nutrient and conductivity behavior remains within acceptable thresholds. If the indicators remain neutral or if measurements are unavailable but other process metrics are stable, the system is configured to maintain the Current Governance State, preventing aggressive changes in the absence of high-confidence risk data.

Conversely, if a conductivity spike, temperature-driven kinetics shift, or nutrient trend indicates elevated biological risk, the system Activates Rescue Logic 505, prioritizing biological stability and effluent quality over energy minimization. This activation triggers a preemptive increase in aeration or a shift in zone distribution to mitigate the detected loading shock. By decoupling these risk indicators from real-time feedback and treating them as supervisory signals, the architecture ensures that the McC AI Group system remains resilient to sensor uncertainty while providing a clear pathway toward autonomous, sensor-agnostic plant operation.

### Airflow Distribution Control

The distribution control module 140 reallocates airflow among zones using zone airflow fractions 141. Airflow redistribution actions 142 are performed to correct operating envelope violations 143 before increasing total airflow. Normalization constraints 144 ensure that the sum of zone airflow fractions equals the governed total airflow 134, subject to rate-of-change and mechanical limits.

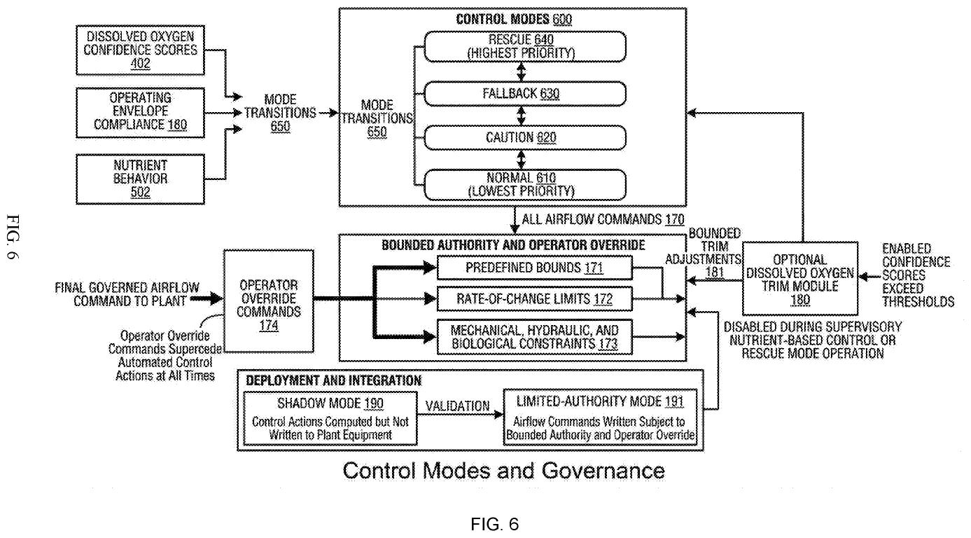

### Control Modes and Governance (FIG. 6)

Referring to FIG. 6, the system operates in multiple control modes 600, including NORMAL 610, CAUTION 620, FALLBACK 630, and RESCUE 640 modes. Mode transitions 650 are governed by dissolved oxygen confidence scores 402, operating envelope compliance 160, and nutrient behavior 502, with higher-priority modes overriding lower-priority modes when necessary.

Bounded Authority and Operator Override: All airflow commands 170 are subject to predefined bounds 171, rate-of-change limits 172, and mechanical, hydraulic, and biological constraints 173. Operator override commands 174 supersede automated control actions at all times.

Optional Dissolved Oxygen Trim: In certain embodiments, an optional minor dissolved oxygen trim module 180 applies bounded trim adjustments 181 when enabled and when confidence scores exceed thresholds. Trim adjustments are disabled during supervisory nutrient-based control or rescue mode operation.

Deployment and Integration: The system may operate in a shadow mode 190, in which control actions are computed but not written to plant equipment. Following validation, the system may operate in a limited-authority mode 191, in which airflow commands are written subject to bounded authority and operator override.

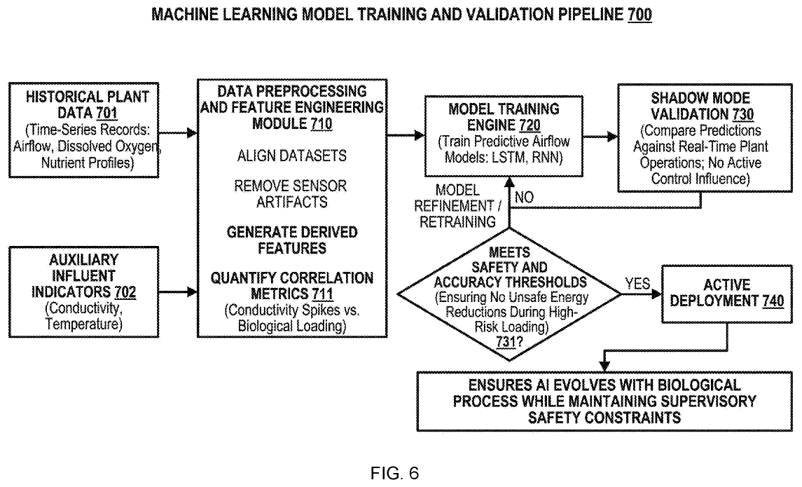

### Machine Learning Model Training and Validation Pipeline (FIG. 7)

Referring to FIG. 7, the machine learning model training and validation pipeline 700 is illustrated. The process begins with the aggregation of Historical Plant Data 701, comprising time-series records of airflow, dissolved oxygen, nutrient profiles, and Auxiliary Influent Indicators 702 (specifically inductive conductivity and temperature). A Data Preprocessing and Feature Engineering Module 710 aligns these datasets, removing sensor artifacts and generating derived features, specifically quantifying the Correlation Metrics 711 between influent conductivity spikes and subsequent biological loading events. These metrics allow the system to maintain a high-fidelity risk profile even in embodiments where physical nutrient sensors are absent or provide low-confidence signals.

The Model Training Engine 720 utilizes this processed data and the correlation features to train time-series-aware predictive models. Preferred embodiments utilize nonlinear, data-driven architectures, such as various neural network topologies or recursive mathematical models, which are specifically suited for the nonlinear, time-lagged dynamics of biological wastewater treatment. This training phase focuses on establishing a baseline relationship between influent characteristics and the corresponding aeration demand required to maintain process stability.

Following training, the model enters a Shadow Mode Validation 730, where its predictions are compared against real-time plant operations and operator-executed actions without influencing active control. This validation phase allows for the calculation of a “Shadow Trust Score,” ensuring the model's recommendations align with safe operational practices before any control authority is granted.

Only upon meeting strict Safety and Accuracy Thresholds 731, ensuring that the model does not recommend unsafe energy reductions during high-risk loading identified by the correlation metrics, is the model promoted to Active Deployment 740. This continuous cycle ensures that the AI evolves with the biological process while maintaining the safety constraints defined in the supervisory governance modules.

### Non-Limiting Nature of the Disclosure

The embodiments described herein are exemplary and not intended to limit the scope of the invention. Variations in evaluation windows, confidence scoring techniques, supervisory logic, and deployment sequencing may be employed without departing from the principles of the invention.

The scope of the invention is defined solely by the appended claims.

1. A system for controlling aeration in a biological wastewater treatment process, the system comprising:
a. a predictive estimation module configured to generate aeration-related recommendations based on process data associated with the wastewater treatment process;
b. physical aeration equipment configured to supply air to at least one biological reactor; and
c. a supervisory governance module interposed between the predictive estimation module and the physical aeration equipment,
wherein the supervisory governance module is configured to evaluate the aeration-related recommendations relative to at least one operational constraint and to selectively permit, constrain, delay, or suppress physical actuation of the recommendations by the physical aeration equipment,
such that predictive estimation is functionally decoupled from physical actuation to maintain stable operation of the physical aeration equipment.

2. A system for controlling aeration in a biological wastewater treatment process configured for low dissolved oxygen operation, comprising:
a. a predictive estimation module configured to generate aeration-related recommendations based on process data associated with a biological reactor operated under conditions supporting simultaneous nitrification and denitrification;
b. physical aeration equipment configured to supply air to the biological reactor; and
c. a supervisory governance module interposed between the predictive estimation module and the physical aeration equipment,
wherein the supervisory governance module is configured to evaluate the aeration-related recommendations relative to at least one low-dissolved-oxygen operational constraint and to selectively permit, constrain, delay, or suppress physical actuation of the recommendations,
wherein the supervisory governance module operates according to a plurality of mode-dependent authority levels including a shadow mode and a limited-authority mode, and
wherein predictive estimation remains functionally decoupled from physical actuation to stabilize aeration behavior under low dissolved oxygen conditions.

3. The system of claim 1, wherein the supervisory governance module operates according to a plurality of mode-dependent authority levels that determine whether and to what extent predictive recommendations are allowed to influence physical aeration control.

4. The system of claim 1, wherein the supervisory governance module selectively permits, constrains, delays, or suppresses actuation based on a current authority mode.

5. The system of claim 2, wherein, in a shadow mode, the predictive estimation module generates aeration-related recommendations that are prevented from modifying physical aeration control signals while being logged or displayed.

6. The system of claim 2, wherein, in a limited-authority mode, actuation of predictive recommendations is permitted only within predefined temporal, magnitude, or rate-of-change bounds.

7. The method of claim 1, further comprising operating initially in a shadow mode, calculating a Shadow Trust Score by comparing computed control actions against operator-executed actions, and inhibiting transition to closed-loop actuation until the Shadow Trust Score exceeds a validation threshold.

8. The method of claim 1, further comprising receiving time-of-use electricity pricing data and logically inhibiting increases in aeration airflow during peak-tariff windows unless biological risk indicators exceed a safety threshold.

9. The system of claim 1, wherein the supervisory governance module suppresses mechanically induced actuator oscillation by limiting at least one of a rate, magnitude, or frequency of aeration setpoint changes.

10. The system of claim 9, wherein suppression of actuator oscillation reduces blower wear and improves energy efficiency relative to direct feedback-based aeration control.

11. The system of claim 1, wherein the supervisory governance module permits operator override of predictive recommendations while maintaining bounded authority over physical actuation.

12. The system of claim 11, wherein operator overrides and governance decisions are logged for audit, validation, or regulatory review.

13. The system of claim 1, wherein the system is configured to operate in a shadow mode during commissioning to validate predictive recommendations under live process conditions while preventing modification of physical aeration control signals.

14. The system of claim 1, wherein the predictive estimation module accounts for hydraulic transport effects within the wastewater treatment process, including at least one of flow propagation delay, hydraulic residence time, or transport-induced load timing, when generating aeration-related recommendations.

15. The system of claim 1, wherein the supervisory governance module computes sensor confidence scores using a weighted combination including at least signal variance, flatlining detection, noise characteristics, and actuator-response consistency, and prevents measurements with low confidence scores from driving high-authority control actions or mode transitions.

16. The system of claim 1, wherein the supervisory governance module generates a virtual biological risk profile using proxy measurements of influent inductive conductivity and wastewater temperature, and historical correlations of said proxies to downstream ammonia or nutrient trends, to enable governance decisions even when nutrient concentration sensors are unavailable, degraded, or excluded.

17. The system of claim 1, wherein the predictive estimation module incorporates hydraulic transport effects, including flow propagation delay and transport-induced timing of load arrival at downstream aeration zones, to produce temporally aligned recommendations that are subsequently governed by the supervisory governance module to prevent localized biological instability.
